(19) United States
(12) Patent Application Publication
(10) Pub. No.: US 2026/0225668 A1
(43) Pub. Date: Aug. 6, 2026

(54) VEHICLE BODY STRUCTURE

(71) Applicants: Hyundai Motor Company, Seoul (KR); Kia Corporation, Seoul (KR)

(72) Inventor: Gyeong Seok Lee, Hwaseong-si (KR)

(21) Appl. No.: 19/203,460

(22) Filed: May 9, 2025

(30) Foreign Application Priority Data
Jan. 31, 2025 (KR) 10-2025-0012418

(51) Int. Cl. B62D 25/20; B60N 2/005; B62D 25/02

(52) U.S. Cl. CPC B62D 25/2036; B60N 2/005; B62D 25/025

(57) ABSTRACT

A vehicle body structure can include a floor panel, a side sill coupled to the floor panel, wherein the side sill can include an external side sill, a first internal side sill coupled to the external side sill, and a second internal side sill coupled to the external side sill, wherein the second internal side sill has a level lower than a level of the first internal side sill, wherein at least one of the first internal side sill or the second internal side sill includes a panel coupling portion extending in a width direction of the floor panel and coupled to the floor panel.

### CROSS-REFERENCE TO RELATED APPLICATIONS

This application claims benefit of priority to Korean Patent Application No. 10-2025-0012418 filed on January 31, 2025 in the Korean Intellectual Property Office, the disclosure of which is incorporated herein by reference in its entirety.

### TECHNICAL FIELD

The present disclosure relates to a vehicle body structure.

### BACKGROUND

As interest in eco-friendly vehicles has increased, interest in electric vehicles has also increased. An electric vehicle may need to have structural stability such that a battery may be safely supported and impact may be safely absorbed in the event of a collision, and a battery may need to be easily replaced and repaired.

Generally, there have been issues that a cross-sectional width of a side sill may change depending on a size of a battery, or that a member may be required on an inner side of a side sill to ensure structural stability, and that design freedom of a vehicle body structure may be reduced.

### SUMMARY

An embodiment of the present disclosure can provide a vehicle body structure that may increase design freedom by independently configuring widths of a first internal side sill and a second internal side sill.

An embodiment of the present disclosure can provide a vehicle body structure that may ensure stability through coupling between structures by changing an assembly order of a reinforcing member and a side sill.

An embodiment of the present disclosure can provide a vehicle body structure that may increase design freedom depending on a battery size while ensuring side collision stability of a vehicle.

According to an embodiment of the present disclosure, a vehicle body structure can include: a side sill; and a floor panel coupled to the side sill, wherein the side sill can include an external side sill; a first internal side sill; and a second internal side sill having a level lower than a level of the first internal side sill, wherein at least one of the first internal side sill or the second internal side sill includes a panel coupling portion extending in a width direction of the floor panel and coupled to the floor panel.

The first internal side sill may include a first panel coupling portion, the second internal side sill may include a second panel coupling portion, and a width of the first panel coupling portion and a width of the second panel coupling portion may be different from each other.

The first internal side sill may include a first inclined surface connected to the first panel coupling portion.

The second internal side sill may include a second inclined surface connected to the second panel coupling portion.

A width of the first panel coupling portion may be longer than a width of the second panel coupling portion, the second panel coupling portion may overlap or underlap at least a portion of the first panel coupling portion, and the first panel coupling portion may be coupled to the floor panel.

The vehicle body structure may further include a seat cross member coupled to the floor panel, and the first internal side sill, the second internal side sill and the seat cross member may form a triple frame structure.

The vehicle body structure may further include a seat cross member coupled to the floor panel; and a coupling member positioned between the seat cross member and the first internal side sill, and the coupling member, the first internal side sill and the second internal side sill may form a triple frame structure.

A width of the second panel coupling portion may be longer than a width of the first panel coupling portion, and the second panel coupling portion may be coupled to the floor panel.

A level of the first panel coupling portion and a level of at least a portion of the second panel coupling portion may be equal.

The second internal side sill may fill a spacing between the first internal side sill and the external side sill.

The vehicle body structure may further include a reinforcing member coupled to the external side sill, the external side sill, the first internal side sill and the second internal side sill may form an internal space, and the reinforcing member may be positioned within the internal space.

The vehicle body structure may further include a sealer connecting the floor panel to the first internal side sill, or the floor panel to the second internal side sill.

According to an embodiment of the present disclosure, a vehicle body structure can include: a dash panel; side sills connected to both sides of the dash panel, respectively; and a floor panel positioned between the side sills, wherein each of the side sills includes an external side sill; a first internal side sill; and a second internal side sill having a level lower than a level of the first internal side sill, wherein at least one of the first internal side sill or the second internal side sill is coupled to the floor panel, and wherein the first internal side sill and the second internal side sill are in contact with each other.

The first internal side sill may include a first panel coupling portion coupled to the floor panel, and a width of the first internal side sill may be longer than a width of the second internal side sill.

The second internal side sill may include a second panel coupling portion coupled to the floor panel, and a width of the second internal side sill may be longer than a width of the first internal side sill.

The second internal side sill may fill a spacing between the first internal side sill and the external side sill, and an intersection region in which the first internal side sill, the second internal side sill, and the external side sill are in contact with each other may be included.

### BRIEF DESCRIPTION OF THE DRAWINGS

The above and other features and advantages of example embodiments of the present disclosure can be more clearly understood from the following detailed description, taken in conjunction with the accompanying drawings, in which:

FIG. 1 is a perspective diagram illustrating a vehicle body structure according to an embodiment of the present disclosure;

FIG. 2 is a cross-sectional diagram illustrating a portion of a vehicle body structure according to an embodiment of the present disclosure;

FIG. 3 is a cross-sectional diagram illustrating a portion of a vehicle body structure according to an embodiment of the present disclosure;

FIG. 4 is a cross-sectional diagram illustrating a portion of a vehicle body structure according to an embodiment of the present disclosure;

FIG. 5 is a cross-sectional diagram illustrating a portion of a vehicle body structure according to an embodiment of the present disclosure;

FIG. 6 is a cross-sectional diagram illustrating a portion of a vehicle body structure according to an embodiment of the present disclosure; and

FIG. 7 is a cross-sectional diagram illustrating a portion of a vehicle body structure according to an embodiment of the present disclosure.

### DETAILED DESCRIPTION OF ILLUSTRATIVE EMBODIMENTS

Hereinafter, example embodiments of the present disclosure will be described with reference to the attached drawings.

Various example embodiments will be described with reference to accompanying drawings. However, the present disclosure is not necessarily limited by the scopes of the example embodiments and a specific embodiment form. Instead, modifications, equivalents, and replacements included in the disclosed concepts and technical scopes of the present disclosure may be employed. Throughout the specification, similar reference numerals can be used for similar elements.

Further, the terms “first,” “second,” and the like may be used to distinguish one element from the other, and may not necessarily limit a sequence and/or an importance, or others, in relation to the elements. In some cases, a first element may be referred to as a second element, and similarly, a second element may be referred to as a first element without departing from the scopes of rights of the present disclosure.

The terms “part,” “portion,” or the like, may be used to describe various components, but the components are not necessarily limited by such terms. Such terms may refer to physically/visibly distinct components, and also to terms describing the function or configuration of a part even when the distinction/division is not necessarily clear, for example.

An expression used in the singular can encompass the expression of the plural, unless it has a clearly different meaning in the context. The terms, “include,” “comprise,” “is configured to,” or the like, of the description are used to indicate the presence of features, numbers, steps, operations, elements, parts, or combinations thereof, and do not exclude the possibilities of combination or addition of one or more features, numbers, steps, operations, elements, parts, or combination thereof.

Unless otherwise indicated, terms used herein, including technical or scientific terms, may mean the same as that which would be commonly understood by a person of ordinary skill in the art to which the present disclosure belongs. Terms defined in commonly used dictionaries can be interpreted as having meanings consistent with the context of the relevant technology.

In the description below, the terms “front,” “rear,” “side,” “back,” “upper and lower,” “top,” “left and right,” or the like, used in relation to direction are defined with respect to a vehicle or a vehicle body structure VB. Also, the terms “first” and “second,” or the like, may be used to describe various components, but these components are not necessarily limited in order, size, position, or importance by the terms, and are denoted only for the purpose of distinguishing one component from another.

In the drawings, D1 may be referred to as a first direction D1, D2 intersecting the first direction D1 may be referred to as a second direction D2, and D3 intersecting each of the first direction D1 and the second direction D2 may be referred to as a third direction D3. The third direction D3 may be referred to as the upward direction, and the opposite direction of the third direction D3 may be referred to as the downward direction. Also, each of the first direction D1 and the second direction D2 may be referred to as the horizontal direction.

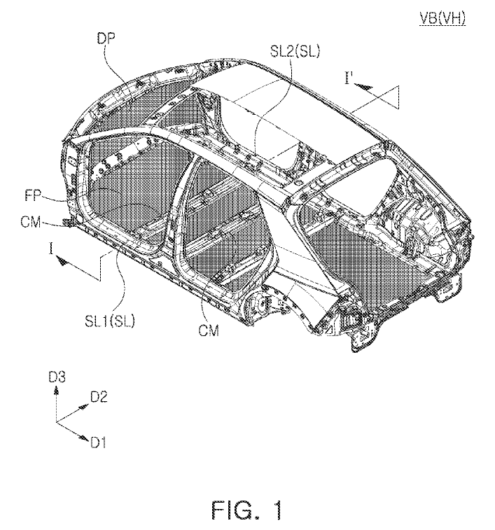

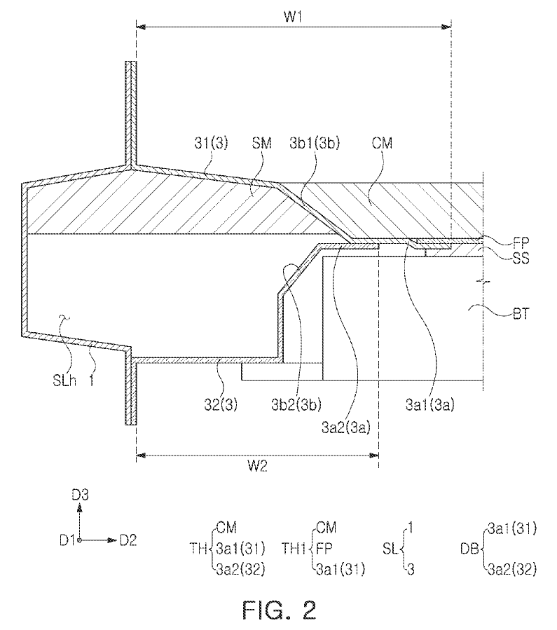

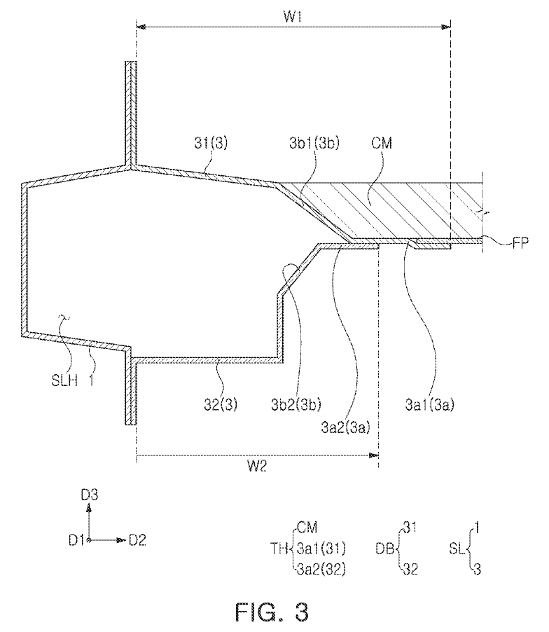

FIG. 1 is a perspective diagram illustrating a vehicle body structure VB according to an example embodiment of the present disclosure. FIG. 2 is a cross-sectional diagram illustrating a portion of a vehicle body structure VB according to an example embodiment of the present disclosure. FIG. 3 is a cross-sectional diagram illustrating a portion of a vehicle body structure VB according to an example embodiment of the present disclosure. FIG. 2 is a portion of a cross-sectional diagram of the vehicle body structure VB taken along line I-I’.

The vehicle body structure VB may support various devices installed in the vehicle VH. For example, the vehicle body structure VB may be coupled to and support various parts such as a seat, various electronic devices used for driving the vehicle VH, a console, a vehicle wheel, a suspension, or the like.

Referring to FIGS. 1 and 2, the vehicle body structure VB according to an embodiment may include a dash panel DP, a side sill SL, a seat cross member CM, and a floor panel FP. The vehicle body structure VB according to an embodiment may optionally include a sealer SS, a battery pack BT, and a reinforcing member SM.

The dash panel DP may work as a wall physically separating an engine bay of the vehicle VH from a cabin, which is a space in which passengers ride. The dash panel DP may be positioned on the front side of the vehicle VH. The dash panel DP may block heat, noise, and vibrations of the engine bay and may ensure passenger safety. Also, the dash panel DP may reduce cabin deformation by absorbing and dispersing impact during collision from the front or side. The dash panel DP may be coupled to various parts such as a heating, ventilation, and air conditioning (HVAC) system, a steering column, or the like, and may provide stability and convenience to the driver. The dash panel DP may be coupled to the side sill SL and A-pillar of the vehicle VH. The dash panel DP may include at least one of high-strength steel, aluminum alloy, and a composite material, but an embodiment thereof is not necessarily limited thereto.

The side sill SL may be a part extending along the periphery of a lower portion of the vehicle body structure VB. The side sill SL may be connected to a bottom edge of both sides of the cabin. The side sill SL may connect an inner part of the vehicle VH to an outer door frame. The side sill SL may protect a passenger by dispersing and absorbing external force during collision of the vehicle VH from the side. External force may include collision energy. Also, the side sill SL may transfer the load of the vehicle VH to the battery pack BT and/or a subframe, or the like, and may ensure balance and structural stability of the vehicle VH.

The side sill SL may be connected to the dash panel DP. The side sill SL may include a first side sill SL1 and a second side sill SL2 connected to the dash panel DP. The first side sill SL1 may be connected to one side (e.g., left side) of the dash panel DP. The second side sill SL2 may be connected to the other side (e.g., right side) of the dash panel DP. The first side sill SL1 and the second side sill SL2 may extend in the first direction D1. The first side sill SL1 and the second side sill SL2 may be spaced apart from each other in the second direction D2 perpendicular to the first direction D1. In the description below, the description of the side sill SL may be applied to either or both of the first side sill SL1 and the second side sill SL2.

Referring to FIGS. 1 and 2, the side sill SL according to an embodiment may include an external side sill 1 and an internal side sill 3. The internal side sill 3 according to an embodiment may include a first internal side sill 31 and a second internal side sill 32.

The external side sill 1 may form a portion of the exterior of the vehicle VH. The external side sill 1 may protect the exterior of the vehicle VH and may reduce external force transferred into the vehicle body structure VB by absorbing external impact. The external side sill 1 may protect the internal structure from external corrosion and damage. The external side sill 1 may include a high-strength steel plate or an aluminum alloy, but an embodiment thereof is not necessarily limited thereto.

The internal side sill 3 may be coupled to the external side sill 1. The internal side sill 3 may be positioned closer to a center of the vehicle VH than the external side sill 1. When the vehicle VH collides, the internal side sill 3 may reduce deformation of the vehicle body structure VB and may contribute to maintaining a safe space for passengers. The internal side sill 3 may effectively distribute the load and may increase structural rigidity of the vehicle VH. The internal side sill 3 may include a metal material, and may be connected to the external side sill 1 and may reinforce the frame structure of the vehicle VH.

According to an embodiment of the present disclosure, the internal side sill 3 may include the first internal side sill 31 and the second internal side sill 32.

The first internal side sill 31 may be coupled to the external side sill 1. The first internal side sill 31 may be positioned between the external side sill 1 and the seat cross member CM. The first internal side sill 31 may connect the external side sill 1 to the seat cross member CM.

The second internal side sill 32 may be coupled to the external side sill 1. The second internal side sill 32 may be coupled to the first internal side sill 31. A level of the first internal side sill 31 may be higher than a level of the second internal side sill 32. The first internal side sill 31 may be positioned on the second internal side sill 32.

The first internal side sill 31 and/or the second internal side sill 32 may be coupled to the floor panel FP. The internal side sill 3 may include a panel coupling portion 3a to be coupled to the floor panel FP. More specifically, the first internal side sill 31 may include a first panel coupling portion 3a1 coupled to the floor panel FP. The second internal side sill 32 may include a second panel coupling portion 3a2 coupled to the floor panel FP. The panel coupling portion 3a may include the first panel coupling portion 3a1 and the second panel coupling portion 3a2. The panel coupling portion 3a may extend in the width direction of the floor panel FP and may be coupled to the floor panel FP. The panel coupling portion 3a may form an external side of the floor panel FP. Coupling stability between the floor panel FP and other components may be increased by the panel coupling portion 3a. At least one of the first panel coupling portion 3a1 or the second panel coupling portion 3a2 may be coupled to the floor panel FP.

In FIG. 2, the first panel coupling portion 3a1 may be coupled to the floor panel FP. A state in which the second panel coupling portion 3a2 can be coupled to the floor panel FP will be described later.

The first internal side sill 31 and the second internal side sill 32 may be in contact with each other and may have a double frame structure DB. More specifically, the first panel coupling portion 3a1 and the second panel coupling portion 3a2 may be in contact with each other and may have a double frame structure DB. The double frame structure DB of the first internal side sill 31 and the second internal side sill 32 may be coupled to other components and a triple frame structure TH may be formed, which will be described later. In the description below, the double frame structure DB by the first internal side sill 31 and the second internal side sill 32 may also be applied to another embodiment.

A width W1 of the first internal side sill 31 and a width W2 of the second internal side sill 32 may be different from each other. The width W1 of the first internal side sill 31 may include a width of the first panel coupling portion 3a1. The width W2 of the second internal side sill 32 may include a width of the second panel coupling portion 3a2. The width of the first panel coupling portion 3a1 and the width of the second panel coupling portion 3a2 may be different from each other. When the first panel coupling portion 3a1 is directly coupled to the floor panel FP, the width W1 of the first internal side sill 31 may be longer than the width W2 of the second internal side sill 32. When the second panel coupling portion 3a2 is directly coupled to the floor panel FP, the width W2 of the second internal side sill 32 may be longer than the width W1 of the first internal side sill 31.

The width W1 of the first internal side sill 31 and the width W2 of the second internal side sill 32 may vary depending on the coupling relationship with other structures, a target, and the shape of other structures. For example, when the width of the side sill SL is relatively narrow, the space for installing the floor panel FP and various parts coupled to the floor panel FP may be expanded. However, when the width of the side sill SL is narrower than a set, selected, or predetermined level, there may be a limitation in molding of the part included in the vehicle VH, such that an additional member may be required to mount the part. Accordingly, by controlling the width of the internal side sill 3, flexibility of design may be increased.

The vehicle body structure VB may ensure collision stability by deforming the width W1 of the first internal side sill 31. The width W1 of the first internal side sill 31 may be controlled to enhance structural stability of the vehicle body structure VB. The vehicle body structure VB may facilitate coupling between the side sill SL or the floor panel FP and other parts by deforming the width W2 of the second internal side sill 32. The width W1 of the first internal side sill 31 and the width W2 of the second internal side sill 32 may be configured independently.

The internal side sill 3 may include an inclined surface 3b. The inclined surface 3b may be connected to the panel coupling portion 3a. A contact area between the internal side sill 3 and another part may be increased by the inclined surface 3b. The coupling force between the internal side sill 3 and another part may be increased by the inclined surface 3b. More specifically, the inclined surface 3b may include a first inclined surface 3b1 and a second inclined surface 3b2. The first internal side sill 31 according to an embodiment may include the first inclined surface 3b1 connected to the first panel coupling portion 3a1. The second internal side sill 32 according to an embodiment may include the second inclined surface 3b2 connected to the second panel coupling portion 3a2.

The external side sill 1 and the internal side sill 3 may have an internal space SLh. The external side sill 1, the first internal side sill 31 and the second internal side sill 32 may have an internal space SLh. The internal space SLh may be a spacing between the external side sill 1, the first internal side sill 31 and the second internal side sill 32. The side sill SL may absorb external impact and may have a light weight due to the internal space SLh.

The reinforcing member SM may be positioned within the internal space SLh. The reinforcing member SM may be coupled to the side sill SL. The reinforcing member SM may be coupled to at least one of the external side sill 1, the first internal side sill 31 or the second internal side sill 32. Due to the reinforcing member SM, rigidity of the side sill SL may be improved and structural stability of the vehicle body structure VB may be improved. The reinforcing member SM may extend in the first direction D1 similarly to the side sill SL.

The floor panel FP may be positioned at the lower portion of the vehicle VH and may evenly distribute the load. The floor panel FP may be coupled to various components of the vehicle body structure VB, such that the floor panel FP may distribute the load and may absorb the impact, thereby protecting a passengers and cargo.

The floor panel FP according to an embodiment may include a front floor, a center floor, and a rear floor. The front floor may be positioned on lower ends of a driver seat and a passenger seat of the vehicle VH. The front floor may divide the space between the engine bay and a passenger room. The center floor may be included in the central portion of the vehicle VH and may connect the front floor to the rear floor. The center floor may distribute the load applied to the entire vehicle body structure VB. The rear floor may be positioned on the rear side of the vehicle VH. The rear floor may support a cargo loading space. The rear floor may be designed to withstand the trunk load and may have impact dissipation capability.

The floor panel FP may be coupled to the seat cross member CM. The seat cross member CM may be coupled to the floor panel FP. The seat cross member CM may be a structure protruding upwardly from the floor panel FP. The seat cross member CM may provide a space through which parts such as a drive shaft, an exhaust pipe, a battery pack BT, and electrical wiring can pass through. The use of the internal space of the vehicle VH may be increased by the seat cross member CM. The seat cross member CM may absorb external force when the vehicle VH collides. The seat cross member CM may connect the side sills SL positioned on both sides of the dash panel DP to each other. The seat cross member CM may connect the first side sill SL1 to the second side sill SL2. The seat cross member CM may extend in the second direction D2.

Referring to FIG. 2, the seat cross member CM, the first internal side sill 31, and the second internal side sill 32 may have a triple frame structure TH. More specifically, the seat cross member CM, the first panel coupling portion 3a1 of the first internal side sill 31, and the second panel coupling portion 3a2 of the second internal side sill 32 may be coupled to each other and may have a triple frame structure TH. Also, the seat cross member CM, the floor panel FP, and the first panel coupling portion 3a1 may have a triple frame structure TH1. The configuration of the triple frame structures TH and TH1 may vary depending on the shape of the side sill SL. Structural rigidity of the vehicle body structure VB may be improved by a multiple frame structure of the internal side sill 3, the seat cross member CM, and the floor panel FP.

A sealer SS may couple the floor panel FP to the internal side sill 3. The sealer SS may connect the floor panel FP, the side sill SL, and the seat cross member CM to each other. The sealer SS may maintain airtightness at a bonding region between different parts and may block infiltration of air, water, dust, or the like. The sealer SS may reinforce structural rigidity at the bonding region of the vehicle VH and may absorb and disperse impact when applied. The sealer SS according to an embodiment may include at least one of a polyurethane-based sealer, a silicone-based sealer, an epoxy-based sealer, or a rubber-based sealer, but the type of the sealer SS is not necessarily limited thereto. Referring to FIG. 2, the sealer SS may connect the floor panel FP to the first internal side sill 31. Also, the sealer SS may connect the floor panel FP to the second internal side sill 32. The position of the sealer SS in FIG. 2 is an example, and the sealer SS may be positioned in an arbitrary position of the vehicle VH.

A battery pack BT may supply power by converting chemical energy into electrical energy to the driving motor and electrical parts of the vehicle VH. The battery pack BT may control voltage, current, and temperature in real time through a BMS (battery management system). The battery pack BT may include cells, an internal insulating material, cooling channels, a battery housing, or the like. The cell may be a basic structure of the battery pack BT including a cathode, an electrolyte, and a separator, may convert chemical energy into electrical energy, and may release or store the energy. Depending on the shape of the cell package surrounding the cell, one of an angular shape, a cylindrical shape, and a pouch shape may be included, but the shape of the cell package is not necessarily limited thereto.

The battery pack BT may be coupled to the floor panel FP. The battery pack BT may be positioned below the floor panel FP. The battery pack BT may be coupled to the second internal side sill 32. At least a portion of the battery pack BT may be coupled to the second internal side sill 32.

Hereinafter, for ease of description, the battery pack BT, the sealer SS, and the reinforcing member SM may not be illustrated. In an embodiment, the battery pack BT, the sealer SS, and the reinforcing member SM may be provided independently regardless of the shape of the internal side sill 3, the battery pack BT, the floor panel FP, and the seat cross member CM.

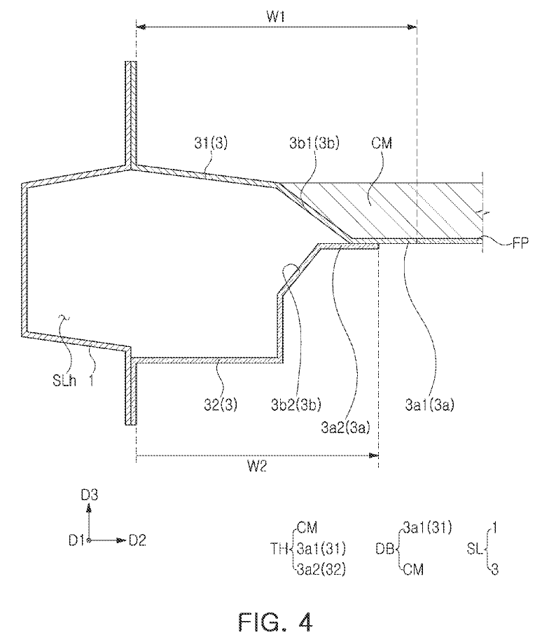

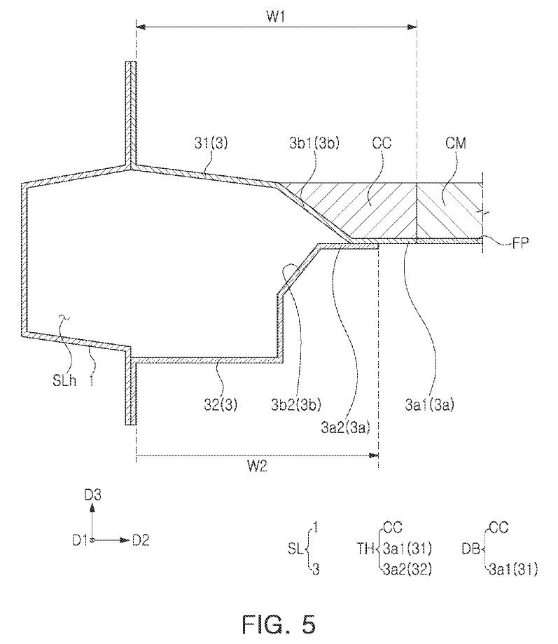

FIG. 3 is a cross-sectional diagram illustrating a portion of a vehicle body structure VB according to an example embodiment of the present disclosure. FIG. 4 is a cross-sectional diagram illustrating a portion of a vehicle body structure VB according to an example embodiment of the present disclosure. FIG. 5 is a cross-sectional diagram illustrating a portion of a vehicle body structure VB according to an example embodiment of the present disclosure.

Referring to FIGS. 3, 4 and 5, a vehicle body structure VB in which a first internal side sill 31 is coupled to a floor panel FP is illustrated, similarly to FIG. 2. Referring to FIGS. 3, 4 and 5, a width W1 of the first internal side sill 31 may be longer than a width W2 of the second internal side sill 32. The width of the first panel coupling portion 3a1 may be longer than the width of the second panel coupling portion 3a2. Referring to FIGS. 3 and 4, the seat cross member CM, the first panel coupling portion 3a1, and the second panel coupling portion 3a2 may be coupled to each other and may have a triple frame structure TH.

Referring to FIG. 3, the first panel coupling portion 3a1 may overlap or underlap the floor panel FP. The first panel coupling portion 3a1 may overlap or underlap at least a portion of the floor panel FP. However, referring to FIG. 4, the first panel coupling portion 3a1 may not overlap or underlap the floor panel FP and may be connected to the floor panel FP. A level of at least a portion of the first panel coupling portion 3a1 may be the same as a level of the floor panel FP. A level of at least a portion of the first panel coupling portion 3a1 may be the same as a level of the second panel coupling portion 3a2. The shape of the first panel coupling portion 3a1 is not necessarily limited thereto, and the first panel coupling portion 3a1 may be coupled to the floor panel FP in various manners. Referring to FIG. 4, the first panel coupling portion 3a1 and the seat cross member CM may be coupled to each other and may have a double frame structure DB. In an embodiment, the configuration of the double frame structure DB may be changed depending on the shape of the side sill SL.

Referring to FIG. 5, a vehicle body structure VB according to an embodiment may optionally include a coupling member CC. The coupling member CC may connect the seat cross member CM to the first internal side sill 31. The coupling member CC may couple the first internal side sill 31 to the seat cross member CM when a length of the seat cross member CM is short or the width W1 of the first internal side sill 31 is short. The coupling member CC may be coupled to the first panel coupling portion 3a1 and the second panel coupling portion 3a2 and may have a triple frame structure TH. The coupling member CC may be coupled to the first panel coupling portion 3a1 and may have a double frame structure DB. The coupling member CC may have an inclined surface in contact with the first inclined surface 3b1. However, the shape of the coupling member CC is not necessarily limited thereto, and various shapes for increasing the coupling force between the first internal side sill 31 and the seat cross member CM may be further included.

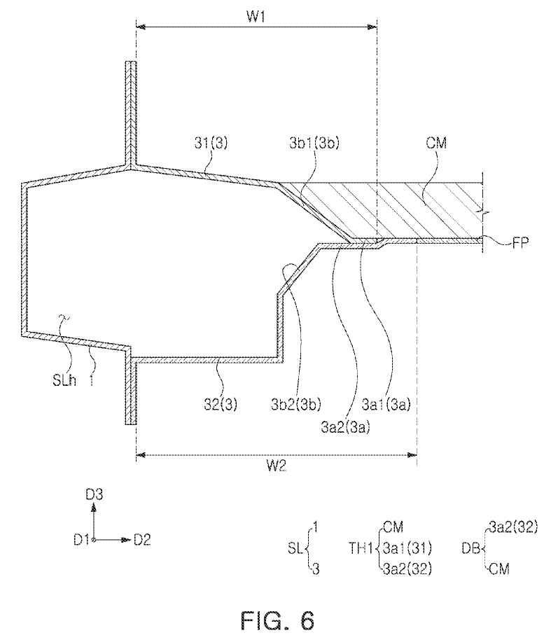

FIG. 6 is a cross-sectional diagram illustrating a portion of a vehicle body structure according to an example embodiment of the present disclosure.

Referring to FIG. 6, a vehicle body structure VB in which a width W2 of a second internal side sill 32 is longer than a width W1 of a first internal side sill 31 may be provided. A width of a second panel coupling portion 3a2 may be longer than a width of a first panel coupling portion 3a1. The second panel coupling portion 3a2 may be coupled to a floor panel FP. The second panel coupling portion 3a2 may overlap or underlap the first panel coupling portion 3a1. A level of at least a portion of the second panel coupling portion 3a2 may be the same as a level of the floor panel FP. A level of at least a portion of the second panel coupling portion 3a2 may be the same as a level of the first panel coupling portion 3a1. The seat cross member CM, the first panel coupling portion 3a1, and the second panel coupling portion 3a2 may be coupled to each other and may have a triple frame structure TH. The seat cross member CM and the second panel coupling portion 3a2 may be coupled to each other and may have a double frame structure DB.

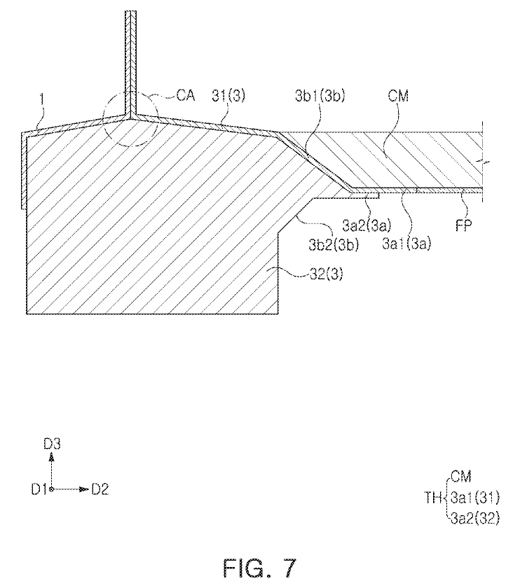

FIG. 7 is a cross-sectional diagram illustrating a portion of a vehicle body structure according to an example embodiment of the present disclosure.

Referring to FIG. 7, a vehicle body structure VB of which an internal space SLh is filled may be provided. A second internal side sill 32 may connect an external side sill 1 to a first internal side sill 31. The second internal side sill 32 may fill a spacing between the external side sill 1 and the first internal side sill 31. The external side sill 1 may overlap or underlap at least a portion of the second internal side sill 32. The first internal side sill 31 may overlap or underlap at least a portion of the second internal side sill 32. A seat cross member CM, a first panel coupling portion 3a1, and a second panel coupling portion 3a2 may be coupled to each other and may have a triple frame structure TH. As the spacing between the external side sill 1 and the first internal side sill 31 is filled with the second internal side sill 32, an intersection region CA in which the first internal side sill 31, the second internal side sill 32, and the external side sill 1 are in contact with each other may be provided.

Referring to FIG. 7, when the second internal side sill 32 fills the spacing between the first internal side sill 31 and the external side sill 1, the first panel coupling portion 3a1 may be coupled to the floor panel FP, but an embodiment thereof is not necessarily limited thereto. Even when the second internal side sill 32 fills the spacing between the first internal side sill 31 and the external side sill 1, the second panel coupling portion 3a2 may be coupled to the floor panel FP.

As for the vehicle body structure VB according to example embodiments, the vehicle body structure VB may have increased design flexibility and may be economical. Because the internal side sill 3 can include the first internal side sill 31 and the second internal side sill 32, the width W1 of the first internal side sill 31 and the width W2 of the second internal side sill 32 may be independently configured in accordance with a size of the part coupled to the side sill SL. For example, when a battery pack BT having a small overall width is mounted on a vehicle VH having a relatively small weight, collision energy that the first internal side sill 31 should absorb may be relatively small. Accordingly, by designing the width W1 of the first internal side sill 31 to be relatively narrow, and designing the width W2 of the second internal side sill 32 to be relatively wide, stability of the vehicle body structure VB may be ensured. An additional structure may not be necessary to connect the side sill SL to the battery pack BT having a relatively small width, and it may be not necessary to entirely design the vehicle body structure VB, cost efficiency may also be increased.

As for the vehicle body structure VB according to example embodiments, structural stability of the vehicle body structure VB may be increased. Because the internal side sill 3 can include the first internal side sill 31 and the second internal side sill 32, it may be easy to position the reinforcing member SM in the internal space SLh. By changing the assembly order of the internal side sill 3 and the reinforcing member SM if desired, the coupling between the reinforcing member SM and the side sill SL may be facilitated and may be structurally stable. For example, by first assembling the reinforcing member SM to the first internal side sill 31 and coupling the second internal side sill 32 to the first internal side sill 31, the assembly of the side sill SL may be facilitated and structural stability may also be increased.

Also, as the panel coupling portion 3a can replace an external side portion of the floor panel FP, the coupling region between the internal side sill 3 and the floor panel FP may be moved to the inner side of the vehicle VH. Accordingly, the sealing operation using the sealer SS between the floor panel FP and the panel coupling portion 3a may be performed independently from other sealing operation of the vehicle VH, such that operations may be performed stably.

Strength of the side sill SL may be stronger than strength of the floor panel FP. A thickness of the side sill SL may be greater than a thickness of the floor panel FP. Because the panel coupling portion 3a of the side sill SL can replace the external side portion of the floor panel FP, deformation of the floor panel FP may be reduced in the event of a collision of the vehicle VH from the side, and safety of passengers may be ensured.

According to the aforementioned example embodiments, by independently configuring the width of the first internal side sill and the second internal side sill, the vehicle body structure may increase design freedom.

According to the aforementioned example embodiments, by changing the assembly order of the reinforcing member and the side sill, the vehicle body structure may ensure stability through coupling between structures.

According to the aforementioned example embodiments, the vehicle body structure may ensure stability of the vehicle during collision from the side, and may increase design freedom depending on a battery size.

A number of embodiments have been disclosed herein. It can be understood that various features of the different embodiments can be combined.

While the example embodiments have been illustrated and described above, it can be apparent to those skilled in the art that modifications and variations could be manufactured without departing from the scopes of the present disclosure as defined by the appended claims, and equivalents thereof.

What is claimed is:

1. A vehicle body structure, comprising:
a floor panel; and
a side sill coupled to the floor panel, wherein the side sill comprises:
an external side sill,
a first internal side sill coupled to the external side sill, and
a second internal side sill coupled to the external side sill, wherein the second internal side sill has a second-internal-side-sill level lower than a first-internal-side-sill level of the first internal side sill, wherein at least one of the first internal side sill or the second internal side sill includes a panel coupling portion extending in a width direction of the floor panel and coupled to the floor panel.

2. The vehicle body structure of claim 1, wherein the first internal side sill includes a first panel coupling portion,
wherein the second internal side sill includes a second panel coupling portion, and
wherein a first-panel-coupling-portion width of the first panel coupling portion and a second-panel-coupling-portion width of the second panel coupling portion are different from each other.

3. The vehicle body structure of claim 2, wherein the first internal side sill includes a first inclined surface connected to the first panel coupling portion.

4. The vehicle body structure of claim 2, wherein the second internal side sill includes a second inclined surface connected to the second panel coupling portion.

5. The vehicle body structure of claim 2,
wherein the first-panel-coupling-portion width of the first panel coupling portion is longer than the second-panel-coupling-portion width of the second panel coupling portion,
wherein the second panel coupling portion overlaps or underlaps at least a portion of the first panel coupling portion, and
wherein the first panel coupling portion is coupled to the floor panel.

6. The vehicle body structure of claim 5, further comprising a seat cross member coupled to the floor panel, wherein the first internal side sill, the second internal side sill, and the seat cross member have a triple frame structure.

7. The vehicle body structure of claim 5, further comprising:
a seat cross member coupled to the floor panel; and
a coupling member positioned between the seat cross member and the first internal side sill, wherein the coupling member, the first internal side sill, and the second internal side sill have a triple frame structure.

8. The vehicle body structure of claim 2, wherein the second-panel-coupling-portion width of the second panel coupling portion is longer than the first-panel-coupling-portion width of the first panel coupling portion, and
wherein the second panel coupling portion is coupled to the floor panel.

9. The vehicle body structure of claim 8, wherein a first-panel-coupling-portion level of the first panel coupling portion and a second-panel-coupling-portion level of at least part of the second panel coupling portion are equal.

10. The vehicle body structure of claim 1, wherein the second internal side sill fills a spacing between the first internal side sill and the external side sill.

11. The vehicle body structure of claim 1, further comprising a reinforcing member coupled to the external side sill,
wherein the external side sill, the first internal side sill, and the second internal side sill form an internal space, and
wherein the reinforcing member is positioned within the internal space.

12. The vehicle body structure of claim 1, further comprising a sealer connecting the floor panel to the first internal side sill, or connecting the floor panel to the second internal side sill.

13. A vehicle body structure, comprising:
a dash panel;
side sills connected to both sides of the dash panel, respectively; and
a floor panel positioned between the side sills, wherein each of the side sills comprises:
an external side sill,
a first internal side sill coupled to the external side sill, and
a second internal side sill,
wherein the second internal side sill has a second-internal-side-sill level lower than a first-internal-side-sill level of the first internal side sill,
wherein at least one of the first internal side sill or the second internal side sill is coupled to the floor panel, and
wherein the first internal side sill and the second internal side sill are in contact with each other.

14. The vehicle body structure of claim 13, wherein the first internal side sill includes a first panel coupling portion coupled to the floor panel, and
wherein a first-internal-side-sill width of the first internal side sill is longer than a second-internal-side-sill width of the second internal side sill.

15. The vehicle body structure of claim 13, wherein the second internal side sill includes a second panel coupling portion coupled to the floor panel, and
wherein a second-internal-side-sill width of the second internal side sill is longer than a first-internal-side-sill width of the first internal side sill.

16. The vehicle body structure of claim 13, wherein the second internal side sill fills a spacing between the first internal side sill and the external side sill, and
wherein the first internal side sill, the second internal side sill, and the external side sill are in contact with each other at an intersection region.

17. A vehicle body structure, comprising:
a floor panel; and
a side sill coupled to the floor panel, wherein the side sill comprises:
an external side sill,
an upper internal side sill coupled to the external side sill, and
a lower internal side sill,
wherein at least one of the upper internal side sill or the lower internal side sill is coupled to the floor panel, and
wherein at least part of the upper internal side sill and the lower internal side sill are overlapping or underlapping with each other at or adjacent the floor panel.

18. The vehicle body structure of claim 17, further comprising a seat cross member coupled to the floor panel, wherein the upper internal side sill, the lower internal side sill, and the seat cross member have a triple frame structure.

19. The vehicle body structure of claim 17, further comprising:
a seat cross member coupled to the floor panel; and
a coupling member positioned between the seat cross member and the upper internal side sill.

20. The vehicle body structure of claim 17, further comprising a reinforcing member coupled to the external side sill,
wherein the external side sill, the upper internal side sill, and the lower internal side sill form an internal space, and
wherein the reinforcing member is positioned within the internal space.
